(19) United States
(12) Patent Application Publication
(10) Pub. No.: US 2016/0017587 A1
(43) Pub. Date: Jan. 21, 2016

(54) SYSTEM FOR TREATING RAINWATER RUNOFF FROM UNDERLYING SURFACE

(71) Applicant: Chongqing University, Chongqing (CN)

(72) Inventors: Qiang HE, Chongqing (CN); Hongxiang CHAI, Chongqing (CN); Wei KANG, Chongqing (CN); Qiang JIANG, Chongqing (CN); Lei KONG, Chongqing (CN); Luwei GUO, Chongqing (CN)

(21) Appl. No.: 14/564,070

(22) Filed: Dec. 8, 2014

(30) Foreign Application Priority Data
Jul. 15, 2014 (CN) 201410334905.2

(51) Int. Cl. E03F 1/00; C02F 3/32

(52) U.S. Cl. CPC E03F 1/001; C02F 3/32; C02F 2103/001

(57) ABSTRACT

A system for treating rainwater runoff from an underlying surface, including: a rainwater collecting facility, a primary runoff treatment facility, a first biological filtration facility, a second biological filtration facility, a third biological filtration facility, and a drainage canal. A pavement open channel is connected to the water inlet of the primary runoff treatment facility. The water outlet of the primary runoff treatment facility is connected to the water inlet of the first biological filtration facility. A square pipeline is connected to the water inlet of the second biological filtration facility. The water outlet of the first biological filtration facility, the water outlet of the second biological filtration facility, and a roof drainage pipeline are connected to the water inlet of the third biological filtration facility. The third biological filtration facility is connected to the drainage canal.

### CROSS-REFERENCE TO RELATED APPLICATIONS

Pursuant to 35 U.S.C. §119 and the Paris Convention Treaty, this application claims the benefit of Chinese Patent Application No. 201410334905.2 filed Jul. 15, 2014, the contents of which are incorporated herein by reference.

### BACKGROUND OF THE INVENTION

1. Field of the Invention

The invention relates to the field of rainwater treatment technology, and more particularly to a system for treating rainwater runoff from an underlying surface.

2. Description of the Related Art

A typical method for treating rainwater is to collect rainwater from different underlying surfaces for common treatment but such a method neglects differences in water quality of rainwater from the different underlying surfaces. Although rainwater from different underlying surfaces is individually treated, the rainwater after treatment is collected for sprinkler irrigation or for further purification, which increases cost.

### SUMMARY OF THE INVENTION

In view of the above-described problems, it is one objective of the invention to provide a system for treating rainwater runoff from an underlying surface so that rainwater is treated at different stages according to different water qualities from different underlying surfaces, so that not only is the structure of the rainwater treatment system simplified, but also the service life of the rainwater treatment system is prolonged, thereby decreasing the costs of operation and maintenance.

To achieve the above objective, in accordance with one embodiment of the invention, there is provided a system for treating rainwater runoff from an underlying surface, the system comprises: a rainwater collecting facility, a primary runoff treatment facility, a first biological filtration facility, a second biological filtration facility, a third biological filtration facility, and a drainage canal. The rainwater collecting facility comprises: a pavement open channel, a square pipeline, and a roof drainage pipeline. The pavement open channel is connected to a water inlet of the primary runoff treatment facility. A water outlet of the primary runoff treatment facility is connected to a water inlet of the first biological filtration facility. The square pipeline is connected to a water inlet of the second biological filtration facility. A water outlet of the first biological filtration facility, a water outlet of the second biological filtration facility, and the roof drainage pipeline are connected to a water inlet of the third biological filtration facility. The third biological filtration facility is connected to the drainage canal.

The rainwater from the pavement is treated by the pavement open channel and the primary runoff treatment facility so as to remove the suspended matters of large particles, the rainwater is intercepted by plants, infiltrated, and filtrated, and then overflows to enter the first biological filtration facility for further treatment. The rainwater from the square passes through the square pipe, enters the second biological filtration facility, and is treated by plants interception, infiltration, and filtration. The two-stage treated rainwater from the pavement, the one-stage treated rainwater from the square, and the rainwater from the roof are accumulated, enter the third biological filtration facility where plant interception, infiltration, and filtration treatments are conducted, the rainwater from different underlying surfaces is drained via the drainage canal to a downstream water body or recovered for use. The rainwater intercepted by plants of different stages replenishes the ground water.

Advantages according to embodiments of the invention are summarized as follows:

Rainwater from different underlying surfaces is treated at different stages, and the carrying load is reasonably allocated by different biological filtration facilities, so that not only is the structure of the rainwater treatment system simplified, but also the service life of the rainwater treatment system is prolonged, thereby decreasing the costs for the operation and the maintenance.

### BRIEF DESCRIPTION OF THE DRAWINGS

The invention is described hereinbelow with reference to the accompanying drawings, in which:

FIG. 1 is a structure diagram of a system for treating rainwater runoff from an underlying surface;

FIG. 2 is a cross sectional view of a primary runoff treatment facility of FIG. 1; and

FIG. 3 is a cross section view of a biological filtration facility of FIG. 1.

In the drawings, the following reference numbers are used: 1. Rainwater collecting facility; 1a. Pavement open channel; 1b. Square pipeline; 1c. Roof drainage pipeline; 2. Primary runoff treatment facility; 21. Sand deposit well; 22. Gravel wall; 23. Grass ditch; 23a. First slag layer; 23b. First sand layer; 23c. First soil layer; 3. First biological filtration facility; 4. Second biological filtration facility; 5. Third biological filtration facility; 6. Drainage canal; 7. Biological filtration pool; 71. Second lawn; 72. Second soil layer; 73. Second sand layer; 74. Second slag layer; 75. Geotextile; 76. Second gravel layer; 8. Water collecting well; and 9. Perforated pipe.

### DETAILED DESCRIPTION OF THE EMBODIMENTS

For further illustrating the invention, experiments detailing a system for treating rainwater runoff from an underlying surface are described below. It should be noted that the following examples are intended to describe and not to limit the invention.

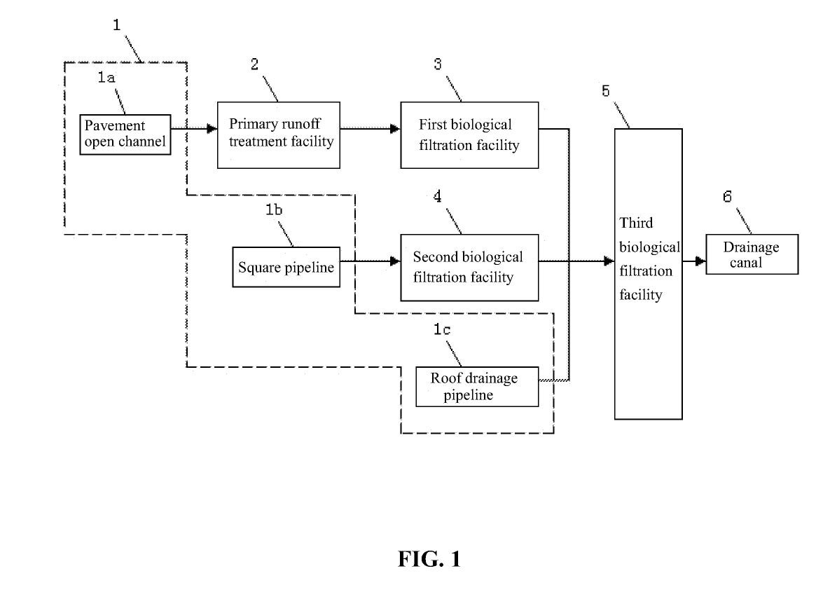

As shown in FIG. 1, a system for treating rainwater runoff from an underlying surface, the system comprises: a rainwater collecting facility 1, a primary runoff treatment facility 2, a first biological filtration facility 3, a second biological filtration facility 4, a third biological filtration facility 5, and a drainage canal 6. The rainwater collecting facility 1 comprises: a pavement open channel 1a, a square pipeline 1b, and a roof drainage pipeline 1c. The pavement open channel 1a is connected to a water inlet of the primary runoff treatment facility 2. A water outlet of the primary runoff treatment facility 2 is connected to a water inlet of the first biological filtration facility 3. The square pipeline 1b is connected to a water inlet of the second biological filtration facility 4. A water outlet of the first biological filtration facility 3, a water outlet of the second biological filtration facility 4, and the roof drainage pipeline 1c are connected to a water inlet of the third biological filtration facility 5. The third biological filtration facility 5 is connected to the drainage canal 6.

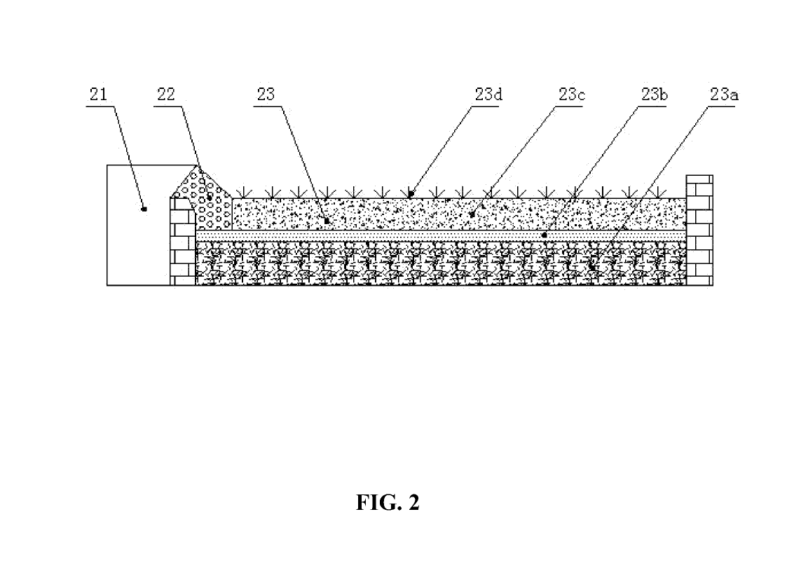

As shown in FIG. 2, the primary runoff treatment facility 2 comprises: a sand deposit well 21, a gravel wall 22, and a grass ditch 23. The sand deposit well 21 is disposed at a front end of the grass ditch 23. The gravel wall 22 is disposed at a wall of the sand deposit well 21 in adjacent to a side of the grass ditch 23. The grass ditch 23 comprises a first slag layer 23a, a first sand layer 23b, a first soil layer 23c, and a first lawn 23d from bottom to top.

The pavement rainwater passes through the pavement open channel 1a and enters the sand deposit well 21 to remove suspended matters of large particles, passes through the gravel wall, and enters the grass ditch where the rainwater is treated by interception, absorption, filtration, and infiltration so that the pollutants in the rainwater is decomposed and transformed. One part of the rainwater after treatment overflows to enter a subsequent treatment facility and the other part replenish the underground water.

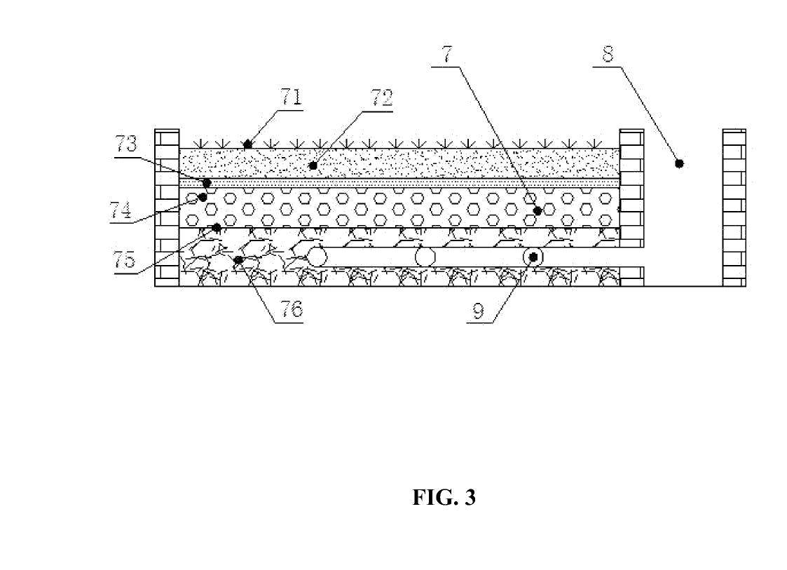

As shown in FIG. 3, biological filtration facilities include the first biological filtration facility 3, the second biological filtration facility 4, and the third biological filtration facility 5. Each of the first biological filtration facility 3, the second biological filtration facility 4, and the third biological filtration facility 5 comprises a biological filtration pool 7 and a water collecting well 8. A perforated pipe 9 is buried in a gravel layer 76 of the biological filtration pool 7. The perforated pipe 9 communicates with the water collecting well 8. The gravel layer 76, a geotextile 75, a second slag layer 74, a second sand layer 73, a second soil layer 72, and a second lawn 71 are arranged in the biological filtration pool 7 from bottom to top. The gravel layer 76 is wrapped by the geotextile 75 for collecting the infiltrated rainwater.

The rainwater enters the biological filtration facilities and is treated by interception, absorption, filtration, and infiltration, so that the water quality is purified, one part of the purified water overflows and enters a subsequent treatment, one part of the purified water is accumulated in the water collecting well 8, and the remaining water replenishes the underground water.

As shown in FIGS. 2-3, the first lawn 23d and the second lawn 71 are planted with Cynodon dactylon (Linn.) Pers. which has strong viability, fast propagation, drought and flood resistance, and trampling resistance, and grows in bunches. The first lawn 23d and the second lawn 71 adopt a mixture of sand and soil, that is, adding 20% of sand based on the original soil so as to increase the permeability coefficient of the soil. The first sand layer 23b and the second sand layer 73 substitute the geotextile and are disposed between the first soil layer 23a and the first slag layer 23c and between the second soil layer 72 and the second slag layer 74, respectively, so as to prevent obstruction resulted from too finely waved geotextile as well as be helpful to the growth of the plant roots. The perforated pipe 6 in the biological filtration pool 7 is PVC pipe and has a longitudinal slop of 0.5%. The infiltrated rainwater is drained into the water collecting well 8, thereby being convenient to measure the water quality.

The system of the invention introduces rainwaters from different underlying surfaces, i. e., the pavement, the roof, and the square, into corresponding treatment units. Functions of the plants, the substrate, and the microbes are combined to decompose and transform the pollutants in the rainwater as well as fully utilize the rainwater to irrigate the plants; specific irrigation of the plants is not required, thereby saving irrigation water.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A system for treating rainwater runoff from an underlying surface, the system comprising:
a) a rainwater collecting facility, the rainwater collecting facility comprising: a pavement open channel, a square pipeline, and a roof drainage pipeline;
b) a primary runoff treatment facility, the primary runoff treatment facility comprising: a sand deposit well, a gravel wall, and a grass ditch;
c) a first biological filtration facility;
d) a second biological filtration facility;
e) a third biological filtration facility; and
f) a drainage canal;
wherein
the pavement open channel is connected to a water inlet of the primary runoff treatment facility;
a water outlet of the primary runoff treatment facility is connected to a water inlet of the first biological filtration facility;
the square pipeline is connected to a water inlet of the second biological filtration facility;
a water outlet of the first biological filtration facility, a water outlet of the second biological filtration facility, and the roof drainage pipeline are connected to a water inlet of the third biological filtration facility; and
the third biological filtration facility is connected to the drainage canal;
the sand deposit well is disposed at a front end of the grass ditch;
the gravel wall is disposed at a wall of the sand deposit well in adjacent to a side of the grass ditch;
the grass ditch comprises a first slag layer, a first sand layer, a first soil layer, and a first lawn from bottom to top;
each of the first biological filtration facility, the second biological filtration facility, and the third biological filtration facility comprises a biological filtration pool and a water collecting well;
a perforated pipe is buried in a gravel layer of the biological filtration pool;
the perforated pipe communicates with the water collecting well; and
the gravel layer, a geotextile, a second slag layer, a second sand layer, a second soil layer, and a second lawn are arranged in the biological filtration pool from bottom to top.

2. The system of claim 1, wherein the first lawn and the second lawn are planted with Cynodon dactylon (Linn)) Pers.

3. The system of claim 2, wherein the perforated pipe in the biological filtration pool has a longitudinal slop of 0.5%.
